(19) United States
(12) Patent Application Publication
(10) Pub. No.: US 2026/0361016 A1
(43) Pub. Date: Nov. 12, 2026

(54) HIGH-SPEED CONNECTOR, ELECTRONIC ASSEMBLY, ELECTRONIC DEVICE, AND SIGNAL TRANSMISSION METHOD

(71) Applicant: HUAWEI TECHNOLOGIES CO., LTD., Shenzhen (CN)

(72) Inventors: Huiru Yan, Dongguan (CN); Zhongming Zhang, Dongguan (CN); Haifeng Tong, Dongguan (CN)

(21) Appl. No.: 19/721,295

(22) Filed: Jun. 26, 2026

Related U.S. Application Data
(63) Continuation of application No. PCT/CN2024/137440, filed on Dec. 6, 2024.

(30) Foreign Application Priority Data
Dec. 29, 2023 (CN) 202311864096.1

(51) Int. Cl. H01R 13/424; H01R 13/502

(52) U.S. Cl. CPC H01R 13/424; H01R 13/502

(57) ABSTRACT

A high-speed connector includes a metal housing and one or more terminals. An end that is of each of the one or more terminals and that faces an insertion/removal end of the high-speed connector is a first terminal part. The metal housing includes a first housing. The first terminal part is located in an inner cavity of the first housing. The first housing of the metal housing serves as a reference ground and a shielding structure for the one or more terminals. A shape of a cross section of the first housing along a first plane is a rounded rectangle. The first plane is perpendicular to an insertion/removal direction of the high-speed connector.

### CROSS-REFERENCE TO RELATED APPLICATIONS

This application is a continuation of International Application No. PCT/CN 2024/137440, filed on Dec. 6, 2024, which claims priority to Chinese Patent Application No. 202311864096.1, filed on Dec. 29, 2023. The disclosures of the aforementioned applications are hereby incorporated by reference in their entireties.

### TECHNICAL FIELD

This application relates to the field of electronic device technologies, and in particular, to a high-speed connector, an electronic assembly, an electronic device, and a signal transmission method.

### BACKGROUND

An electronic device usually includes a plurality of electronic assemblies. Signal transmission needs to be performed between the plurality of electronic assemblies. With continuous evolution of current electronic devices, a quantity of transmitted signals increases, and a transmission rate is higher. As an important part in signal transmission, a high-speed connector also has important impact on a running rate of an electronic device. Therefore, a high requirement is also imposed on a signal transmission rate of the high-speed connector. In addition to the signal transmission rate, requirements are increasingly higher for crosstalk, a delay, signal integrity, stability, and anti-interference of signal transmission by the high-speed connector.

### SUMMARY

This application provides a high-speed connector, an electronic assembly, an electronic device, and a signal transmission method. The high-speed connector has good signal transmission performance, to help improve performance of the electronic assembly and the electronic device.

According to a first aspect, this application provides a high-speed connector. The high-speed connector includes a metal housing and one or more terminals. An end that is of each of the one or more terminals and that faces an insertion/removal end of the high-speed connector is a first terminal part. The metal housing includes a first housing. The first terminal part is located in an inner cavity of the first housing. The first housing of the metal housing serves as a reference ground and a shielding structure for the one or more terminals. A shape of a cross section of the first housing along a first plane is a rounded rectangle. The first plane is perpendicular to an insertion/removal direction of the high-speed connector. The first housing includes four flat plates and four arc plates. The arc plate is merely configured to implement a transitional connection between two adjacent flat plates. The flat plates of the first housing have a large area. The first housing of the metal housing may be fabricated through a metal stamping process. The flat plate of the first housing has a large area, and a process of fabricating the flat plate is simple. In addition, the metal housing can be directly formed by processing the flat plate, with a few processing steps. The flat plate is not prone to internal stress, and a fabrication tolerance of the flat plate is easy to control, to help improve fabrication precision of the first housing of the metal housing. Therefore, it is easy to precisely fabricate the metal housing in this solution with a designed theoretical value, to implement the metal housing with high precision. This can improve signal transmission performance of the high-speed connector. For example, the high-speed connector can have properties such as good circuit impedance continuity, small crosstalk, a low delay, high signal integrity, high stability, and strong anti-interference.

In a further technical solution, the high-speed connector further includes an insulation block. The insulation block is assembled in the metal housing. The insulation block includes one or more accommodation holes. The one or more terminals pass through the one or more accommodation holes. The insulation block may be fabricated through an injection molding process, and is adapted to the first housing in the shape of the rounded rectangle. The insulation block has a simple and regular structure, to help improve its precision and facilitate assembly. A shape of a cross section of a part of the insulation block in the first housing along the first plane is also approximately a rounded rectangle, to help simplify transmission impedance design of the high-speed connector and improve performance of transmitting a high-speed signal by the high-speed connector.

When the insulation block is specifically implemented, an outer circumferential surface that is of the insulation block and that faces the metal housing may include a plurality of protrusion structures. Surfaces that are of the plurality of protrusion structures and that face the metal housing are attached to the metal housing. Space between adjacent protrusion structures is equivalent to an air column. Dimensions, a quantity, and positions of air columns may be synchronously set by adjusting dimensions, a quantity, and positions of the protrusion structures, to precisely design a dielectric constant of the high-speed connector, implement impedance continuity, and further improve the transmission performance of the high-speed connector.

In a specific technical solution, the protrusion structure is a strip-shaped protrusion extending in the insertion/removal direction of the high-speed connector, so that the insulation block has a continuous structure in the insertion/removal direction of the high-speed connector, and impedance continuity can also be implemented in the insertion/removal direction of the high-speed connector.

In a technical solution, the insulation block includes a first part and a second part that are sequentially arranged in a direction away from the insertion/removal end. The first part and the second part are located in the inner cavity of the first housing. An area of a cross section of the first part along the first plane is less than an area of a cross section of the second part along the first plane. The first part may be configured to be inserted into an accommodation groove of a peer connector. When there is a gap between the high-speed connector and the peer connector, a medium (the first part) exists on a plane on which the gap is located. In this way, impedance of the high-speed connector is continuous, to help improve signal transmission performance. In addition, the high-speed connector can have greater demating (Demating) compatibility.

When the foregoing technical solution is specifically implemented, each circumferential side surface of the first part is a first inclined surface. The first inclined surface may be specifically a continuous inclined surface, a stepped inclined surface, a plane, a curved surface, an arc surface, or the like. The first inclined surface includes a first end and a second end that are sequentially arranged in the direction away from the insertion/removal end. A distance between the first end and an adjacent surface of the metal housing is greater than a distance between the second end and the adjacent surface of the metal housing. In a technical solution, in a plurality of cross sections of the first part along the first plane, the cross section closer to the second part has a larger area. The first inclined surface is inclined to be close to the surface of the metal housing in the direction away from the insertion/removal end. In addition to implementing impedance continuity, the first inclined surface in this embodiment may serve as a guiding surface to facilitate insertion of the peer connector into the high-speed connector.

For ease of assembling the terminal, the insulation block further includes a groove. The groove is located on a side that is of the one or more accommodation holes and that is away from the insertion/removal end. The groove communicates with the one or more accommodation holes. The terminal is assembled from the groove and inserted into the accommodation hole in the insertion/removal direction of the high-speed connector. The insulation block includes a limiting rod. The limiting rod is located on a side wall of the groove and spaced apart from a bottom of the groove. The limiting rod and the bottom of the groove are configured to limit the terminal, to reduce a probability of terminal withdrawal and lower a risk of pin back-out.

In a technical solution, the terminal further includes a second terminal part connected to the first terminal part. An included angle is formed between the first terminal part and the second terminal part. A first surface of the first terminal part includes a protrusion part. The protrusion part includes a second inclined surface. The second inclined surface includes a third end and a fourth end that are sequentially arranged in the direction away from the insertion/removal end. A distance between the third end and the first surface is less than a distance between the fourth end and the first surface. An included angle between the second inclined surface and an end face that is of the protrusion part and that is away from the insertion/removal end is an acute angle. Specifically, with a barbed structure, the protrusion part is a ratchet tooth on the first terminal part. In this way, when the first terminal part moves relative to the insulation block in the direction away from the insertion/removal end, large friction between the protrusion part and an inner wall of the accommodation hole helps increase difficulty of withdrawing the terminal from the insulation block and lower the risk of pin back-out.

In a technical solution, there is a guiding surface at an edge of a surface that is of the second terminal part and that faces the insertion/removal end, so that the second terminal part easily crosses the limiting rod. A surface that is of the second terminal part and that is away from the insertion/removal end is a plane, so that the surface that is of the second terminal part and that is away from the insertion/removal end is reliably clamped to the limiting rod.

The metal housing further includes a second housing. The second housing is connected to the first housing. Specifically, the second housing is located on a side that is of the first housing and that is away from the insertion/removal end. The second terminal part is located in an inner cavity of the second housing. The second housing may serve as a reference ground and a shielding structure for the second terminal part. A metal plate is detachably assembled in the second housing. The metal plate is located on a side that is of the second terminal part and that is away from the insertion/removal end. The metal plate shields a signal from the side that is of the second terminal part and that is away from the insertion/removal end. The second housing and the metal plate may also shield interference of the terminal, to improve the signal transmission performance of the high-speed connector.

In a further technical solution, the high-speed connector further includes a protective sleeve. The protective sleeve is sleeved on an outer side of the first housing and fastened to the metal housing. The protective sleeve may be specifically an insulation protective sleeve, configured to protect the first housing. An inner side that is of the protective sleeve and that faces the first housing includes at least one guiding groove. The guiding groove extends in the insertion/removal direction of the high-speed connector. The guiding groove may serve as a guiding structure, to facilitate a connection between the high-speed connector and the peer connector. It may further serve as a foolproof structure with different quantities or positions of guiding grooves for different types of connectors, to prevent incorrect insertion of high-speed connectors with different functions and models.

The protective sleeve specifically includes a first side plate, a second side plate, a third side plate, and a clamping plate. The first side plate is opposite to the second side plate. The third side plate is opposite to the clamping plate. A distance between the clamping plate and the third side plate is greater than a distance between the third side plate and an end that is of the first side plate and that is away from the third side plate. The clamping plate is connected to the first side plate through a first arc-shaped plate. The distance between the clamping plate and the third side plate is greater than a distance between the third side plate and an end that is of the second side plate and that is away from the third side plate. The clamping plate is connected to the second side plate through a second arc-shaped plate. The first arc-shaped plate, the clamping plate, and the second arc-shaped plate enclose a clamping opening. Two ends of the clamping plate are connected to the side plates at the two ends through the arc-shaped plates, to improve a force-bearing form of the clamping plate and help enhance structural strength of the protective sleeve.

To enhance strength of the clamping opening of the protective sleeve, the first arc-shaped plate and the second arc-shaped plate may be further provided with a reinforcing part, for example, a reinforcing rib or a reinforcing block, so that structural strength of positions at which the first arc-shaped plate and the second arc-shaped plate are located is strong, and connections between the clamping plate and both the first side plate and the second side plate have strong strength and are not prone to damage.

The high-speed connector further includes a stop pin. The protective sleeve includes a through hole. The metal housing includes a clamping groove. The stop pin passes through the through hole and is clamped into the clamping groove, to fasten the protective sleeve to the metal housing, with a simple assembly manner.

To improve connection reliability, a surface of the stop pin includes a first bump and a second bump. The first bump abuts against an inner wall of the through hole of the protective sleeve. The second bump abuts against a side wall of the clamping groove of the metal housing. An area of an orthographic projection of the second bump on the surface of the stop pin is greater than an area of an orthographic projection of the first bump on the surface of the stop pin. Because a surface of the metal housing and a surface of the insulation block deform to different degrees, and the area of the second bump is greater than the area of the first bump, a contact area of the second bump and the surface of the metal housing is greater than a contact area of the first bump and the insulation block, so that the stop pin is reliably fastened in the through hole and the clamping groove, to improve reliability of fastening the protective sleeve to the metal housing.

According to a second aspect, this application further provides an electronic assembly. The electronic assembly includes an electronic component and the high-speed connector according to the first aspect. The electronic component is electrically connected to the one or more terminals of the high-speed connector. The high-speed connector of the electronic assembly has good signal transmission performance, so that the electronic assembly has good performance.

According to a third aspect, this application further provides an electronic device. The electronic device includes a peer connector and the electronic assembly according to the second aspect. The peer connector is inserted into the high-speed connector. The high-speed connector has good signal transmission performance, so that the electronic device has good performance.

According to a fourth aspect, this application further provides a signal transmission method. In the signal transmission method, a signal is transmitted through the high-speed connector according to the first aspect. The one or more terminals of the high-speed connector include a power terminal and a communication terminal. The signal transmission method specifically includes: transmitting a power signal through the power terminal; and transmitting a communication signal through the communication terminal. When signals are transmitted through the high-speed connector, both signal quality and a signal transmission rate are high.

### BRIEF DESCRIPTION OF DRAWINGS

FIG. 1 is a diagram of a structure of a high-speed connector according to an embodiment of this application;

FIG. 2 is a schematic exploded view of a structure of a high-speed connector according to an embodiment of this application;

FIG. 3 is a schematic sectional view of a structure of a high-speed connector according to an embodiment of this application;

FIG. 4 is a schematic sectional view of a structure of a first housing according to an embodiment of this application;

FIG. 5 is a diagram of comparison between performance of a high-speed connector according to an embodiment of this application and performance of a connector in the conventional technology;

FIG. 6 is a diagram of a structure of an insulation block according to an embodiment of this application;

FIG. 7 is a diagram of a structure of an end face of an insulation block and a first housing according to an embodiment of this application;

FIG. 8 is a schematic side view of a structure of an insulation block and a first housing according to an embodiment of this application;

FIG. 9 is a diagram of a structure in which a peer connector is inserted into a high-speed connector according to an embodiment of this application;

FIG. 10 is a diagram of a structure in which a peer connector is inserted into a high-speed connector in the conventional technology;

FIG. 11 is a schematic side view of a structure of an insulation block and a first housing according to an embodiment of this application;

FIG. 12 is a partial sectional view of an insulation block and a terminal according to an embodiment of this application;

FIG. 13 is a diagram of a structure of a terminal according to an embodiment of this application;

FIG. 14 is a schematic rear view of a structure of a high-speed connector according to an embodiment of this application;

FIG. 15 is a diagram of a structure with a metal plate removed according to an embodiment of this application;

FIG. 16 is a diagram of a structure of a metal plate according to an embodiment of this application;

FIG. 17 is a diagram of a structure of a protective sleeve according to an embodiment of this application;

FIG. 18 is a schematic front view of a structure of a protective sleeve according to an embodiment of this application;

FIG. 19 is a diagram of different manners of providing a guiding groove of a protective sleeve according to an embodiment of this application; and

FIG. 20 is a diagram of a structure of a stop pin according to an embodiment of this application.

### REFERENCE NUMERALS

100: high-speed connector; 200: peer connector;
00: insertion/removal end; 1: metal housing;
11: first housing; 111: first straight edge;
112: second straight edge; 113: third straight edge;
114: fourth straight edge; 115: arc edge;
12: second housing; 121: metal plate;
1211: protrusion; 122: slot;
13: clamping groove; 2: insulation block;
21: accommodation hole; 22: protrusion structure;
23: first symmetry axis; 24: second symmetry axis;
25: first part; 251: first inclined surface;
2511: first end; 2512: second end;
26: second part; 27: groove;
271: groove bottom; 28: limiting rod;
3: protective sleeve; 31: guiding groove;
32: first side plate; 33: second side plate;
34: third side plate; 35: clamping plate;
36: first arc-shaped plate; 37: second arc-shaped plate;
38: through hole; 4: terminal;
41: first terminal part; 411: protrusion part;
4111: second inclined surface; 41111: third end;
41112: fourth end; 42: second terminal part;
421: guiding surface; 5: stop pin;
51: first bump; 52: second bump;
O: center point; M: insertion/removal direction.

### DESCRIPTION OF EMBODIMENTS

To make the objectives, technical solutions, and advantages of this application clearer, the following further describes this application in detail with reference to the accompanying drawings.

Terms used in the following embodiments are merely intended to describe specific embodiments, but are not intended to limit this application. The terms “one”, “a”, “an”, “the”, and “this” of singular forms used in this specification and the appended claims of this application are also intended to include expressions such as “one or more”, unless otherwise specified in the context clearly.

Reference to “an embodiment”, “a specific embodiment”, or the like described in this specification means that a specific feature, structure, or characteristic described with reference to the embodiment is included in one or more embodiments of this application. The terms “include”, “comprise”, “have”, and their variants all mean “include but are not limited to”, unless otherwise specifically emphasized in another manner.

To facilitate understanding of a high-speed connector, an electronic assembly, an electronic device, and a signal transmission method provided in embodiments of this application, the following first describes their application scenario.

The electronic device in embodiments of this application may be a communication device (for example, a router), a compute device (for example, a server), a network device (for example, a switch), a storage device (for example, a storage array), a vehicle (for example, a vehicle including a vehicle-mounted device such as a sensor), or another electronic device, especially an electronic device requiring transmission of high-speed signals. A specific type of the electronic device is not limited in this application. The technical solutions provided in this application may be used for any electronic device that implements signal transmission through the high-speed connector.

For ease of description, an application scenario of the solutions is described by using an example in which the electronic device is a vehicle. An application scenario in which the electronic device is of another type is not described in detail herein. With the advent of the internet of vehicles era and the popularity of intelligent driving, more data needs to be collected and processed at a higher speed. For example, transmitting signals of sensors such as a camera, a radar, and a lidar inside and outside a vehicle, transmitting signals between sensors of vehicles, transmitting signals between a vehicle and a network apparatus, transmitting signals between a vehicle and an infrastructure, or the like requires massive data to be generated, sent, received, stored, and processed. A vehicle is full of electronic chips and board-level systems that communicate through high-speed networks and buses. Because the high-speed connector is an important structure on a signal transmission path, customizing or selecting a high-speed connector with good performance is a top priority in a vehicle development process, regardless of whether the connector is used for entertainment or autonomous driving.

As automotive intelligent networking continuously advances, in-vehicle infotainment functions are constantly improving. An autonomous driving computing platform with high computing power and a large quantity of in-vehicle sensors are successively disposed in a vehicle, imposing higher requirements on an information transmission rate and other performance of the high-speed connector. In addition to good circuit impedance continuity, small crosstalk, a low delay, and high signal integrity, transmission of high-speed data signals requires properties such as high stability, anti-interference, and resistance to high temperature. To implement the foregoing performance of the high-speed connector, in addition to optimizing a structure of the high-speed connector, problems such as a tolerance in a process of fabricating the high-speed connector and whether a design solution can be implemented precisely and reliably need to be considered.

A structure in which the high-speed connector is assembled in the electronic device is the electronic assembly. The electronic assembly may be specifically a circuit board assembly, a module assembly, or the like. For example, the electronic assembly may include an electronic component and the high-speed connector. The high-speed connector includes a terminal. The electronic component is electrically connected to the terminal of the high-speed connector. In an optional embodiment, the electronic component is electrically connected to the terminal of the high-speed connector through a circuit board. The electronic assembly is formed into a board structure. Specifically, the electronic component and the high-speed connector may be fastened to the circuit board, the electronic component is connected to a circuit of the circuit board, and the high-speed connector is also connected to the circuit of the circuit board, to connect the electronic component to the high-speed connector. In an optional embodiment, the electronic component may alternatively be electrically connected to the high-speed connector through an electrical transmission component. For example, the electrical transmission component may be a lead, a flexible circuit board, a cable, or the like.

The electronic device further includes a peer connector. The peer connector is inserted into the high-speed connector, to implement signal transmission between the electronic assembly with the high-speed connector and an electronic assembly with the peer connector.

The high-speed connector provided in this application is configured to transmit a high-speed signal. For example, a transmission rate of the signal is greater than or equal to 10 Gps. In addition, the high-speed connector may be further configured to transmit a high-frequency signal.

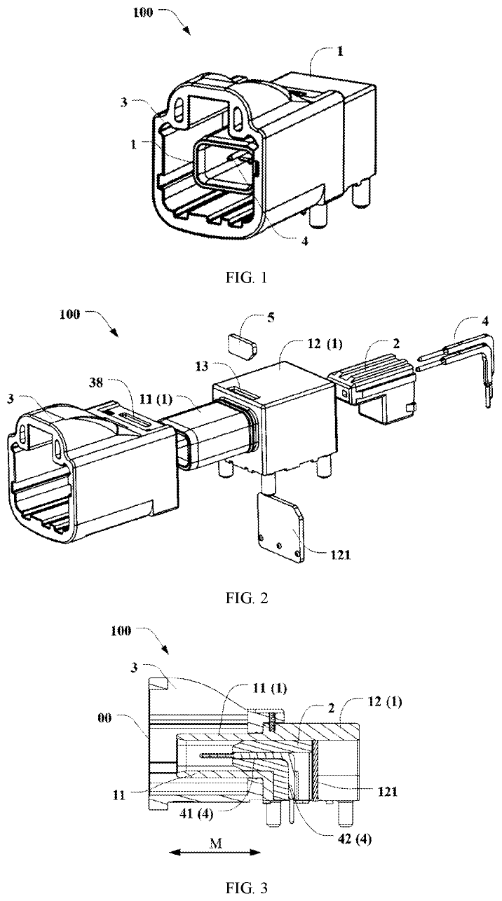

FIG. 1 is a diagram of a structure of a high-speed connector according to an embodiment of this application. FIG. 2 is a schematic exploded view of a structure of a high-speed connector according to an embodiment of this application. As shown in FIG. 1 and FIG. 2, in an embodiment, a high-speed connector 100 in this application includes a metal housing 1, an insulation block 2, and one or more terminals 4. In a specific embodiment, the high-speed connector 100 may include one, two, or more terminals 4. In a possible embodiment, a quantity of the one or more terminals 4 included in the high-speed connector 100 is an even number. Every two terminals 4 are configured to transmit a pair of differential signals. The one or more terminals 4 are fastened to the insulation block 2, and the insulation block 2 is fastened to the metal housing 1, to form the high-speed connector 100.

With continued reference to FIG. 1 and FIG. 2, the connector in this application may further include a protective sleeve 3. The metal housing 1 is fastened to the protective sleeve 3. The protective sleeve 3 may protect the metal housing 1, and may be provided with a clamping structure or the like configured to connect to the peer connector, to improve reliability of a connection between the connector in embodiments of this application and the peer connector.

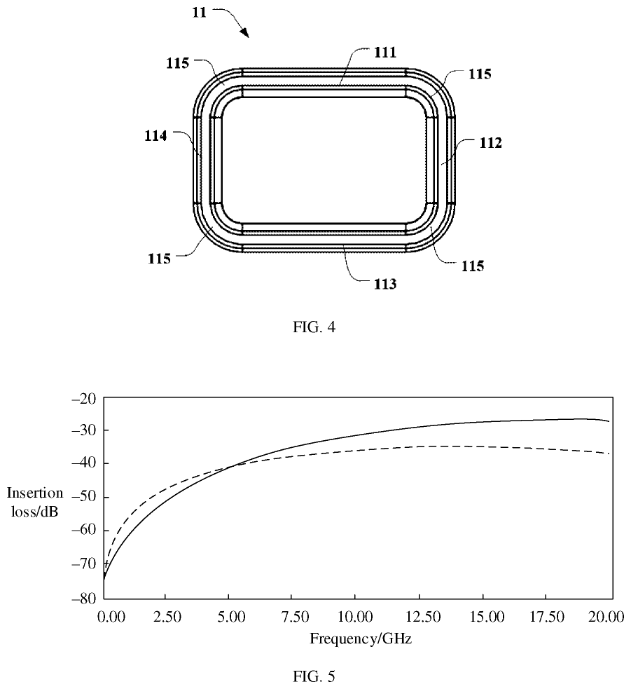

FIG. 3 is a schematic sectional view of a structure of a connector according to an embodiment of this application. As shown in FIG. 3, in embodiments of this application, an end that is of each terminal 4 and that faces an insertion/removal end 00 of the high-speed connector 100 is a first terminal part 41. The metal housing 1 includes a first housing 11. The first terminal part 41 is located in an inner cavity of the first housing 11. The first housing 11 may serve as a reference ground and a shielding structure for the one or more terminals 4. FIG. 4 is a schematic sectional view of a structure of the first housing 11 according to an embodiment of this application. With reference to FIG. 4, a shape of a cross section of the first housing 11 along a first plane is a rounded rectangle. The first plane is specifically perpendicular to an insertion/removal direction M of the high-speed connector 100. The shape of the cross section of the first housing 11 along the first plane specifically includes four straight edges. The four straight edges include a first straight edge 111, a second straight edge 112, a third straight edge 113, and a fourth straight edge 114 that are sequentially arranged in a circumferential direction. The first straight edge 111 has a same length as and is parallel to the third straight edge 113. The second straight edge 112 has a same length as and is parallel to the fourth straight edge 114. The first straight edge 111 is perpendicular to the second straight edge 112. In addition, an orthographic projection of the first straight edge 111 on the third straight edge 113 coincides with the third straight edge 113, and an orthographic projection of the second straight edge 112 on the fourth straight edge 114 coincides with the fourth straight edge 114. An arc edge 115 is connected between any two adjacent straight edges, allowing for a rounded transition between the two adjacent straight edges.

From a perspective of a three-dimensional structure of the metal housing 1, the first housing 11 encloses an accommodation cavity. The accommodation cavity extends in the insertion/removal direction M of the high-speed connector 100. The first terminal part 41 is located in the accommodation cavity. The accommodation cavity includes four side plates and four arc plates. The side plates are flat plates. The four side plates and the four arc plates are alternately arranged in the circumferential direction to enclose the accommodation cavity. The four side plates include a fourth side plate, a fifth side plate, a sixth side plate, and a seventh side plate that are sequentially arranged in the circumferential direction. The fourth side plate is parallel to the sixth side plate. The fifth side plate is parallel to the seventh side plate. The fourth side plate is perpendicular to the fifth side plate. Adjacent side plates are connected through an arc plate.

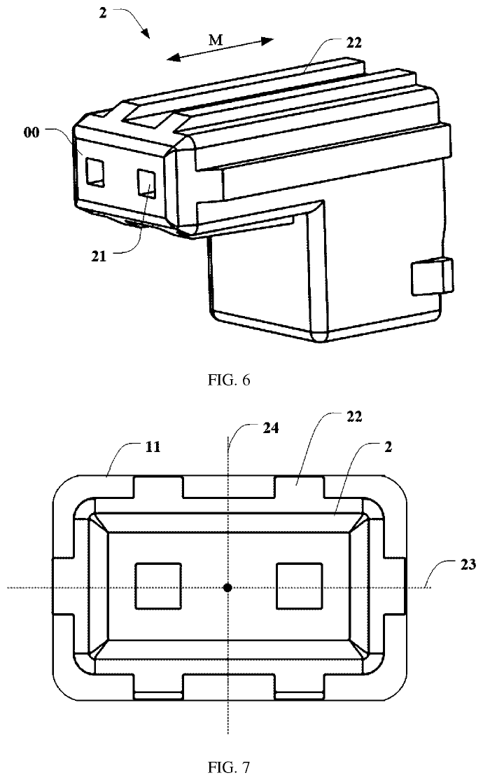

When the first housing 11 is specifically fabricated, the first housing 11 of the metal housing 1 may be fabricated through a metal stamping process. In this solution, the flat plate of the first housing 11 has a large area, and a process of fabricating the flat plate is simple. In addition, the metal housing 1 can be directly formed by processing the flat plate, with a few processing steps. The flat plate is not prone to internal stress, and a fabrication tolerance of the flat plate is easy to control, to help improve fabrication precision of the first housing 11 of the metal housing 1. Therefore, it is easy to precisely fabricate the metal housing 1 in this solution with a designed theoretical value, to implement the metal housing 1 with high precision. This can improve signal transmission performance of the high-speed connector 100. For example, the high-speed connector 100 can have properties such as good circuit impedance continuity, small crosstalk, a low delay, high signal integrity, high stability, and strong anti-interference. Specifically, FIG. 5 is a diagram of comparison between performance of a high-speed connector according to an embodiment of this application and performance of a connector in the conventional technology. As shown in FIG. 5, a solid line indicates the performance of the connector in the conventional technology, and a dashed line indicates the performance of the high-speed connector 100 in embodiments of this application. It can be learned that the performance of the high-speed connector 100 in embodiments of this application is better than the performance of the connector in the conventional technology.

FIG. 6 is a diagram of a structure of the insulation block 2 according to an embodiment of this application. FIG. 7 is a diagram of a structure of an end face of the insulation block 2 and the first housing 11 according to an embodiment of this application, which is specifically a diagram of a structure of an end face that is of the insulation block 2 and the first housing 11 and that faces the insertion/removal end 00. With reference to FIG. 2, FIG. 3, FIG. 6, and FIG. 7, in an embodiment, the insulation block 2 is assembled in the metal housing 1. The insulation block 2 includes one or more accommodation holes 21. The one or more terminals 4 in the high-speed connector 100 pass through the one or more accommodation holes 21. Specifically, in an embodiment, a quantity of the accommodation holes 21 in the insulation block 2 may be the same as the quantity of the one or more terminals 4 in the high-speed connector 100. The accommodation holes 21 are in a one-to-one correspondence with the one or more terminals 4. One terminal 4 passes through one accommodation hole 21. In an embodiment, the quantity of the accommodation holes 21 in the insulation block 2 may alternatively be less than the quantity of the one or more terminals 4 in the high-speed connector 100. Two or more terminals 4 are disposed in one accommodation hole 21. In an embodiment, the insulation block 2 may alternatively include one accommodation hole 21. All terminals 4 pass through the accommodation hole 21. Specific implementation may not be limited to the foregoing several embodiments, and a relationship between the accommodation hole 21 and the terminal 4 may alternatively be designed based on another requirement. The insulation block 2 may be fabricated through an injection molding process, and is adapted to the first housing 11 in the shape of the rounded rectangle. The insulation block 2 has a simple and regular structure, to help improve its precision and facilitate assembly. A shape of a cross section of a part of the insulation block 2 in the first housing 11 along the first plane is also approximately a rounded rectangle, to help simplify transmission impedance design of the high-speed connector 100 and improve performance of transmitting a high-speed signal by the high-speed connector 100.

With reference to FIG. 6 and FIG. 7, an outer circumferential surface that is of the insulation block 2 and that faces the metal housing 1 includes a plurality of protrusion structures 22. Specifically, the protrusion structures 22 extend in the insertion/removal direction M of the high-speed connector 100. Surfaces that are of the plurality of protrusion structures 22 and that face the metal housing 1 are attached to the metal housing 1. Space between adjacent protrusion structures 22 is equivalent to an air column. Dimensions, a quantity, and positions of air columns may be synchronously set by adjusting dimensions, a quantity, and positions of the protrusion structures 22, to precisely design a dielectric constant of the high-speed connector 100, implement impedance continuity, and further improve the transmission performance of the high-speed connector 100.

In a specific embodiment, the insulation block 2 is of a symmetric structure. Specifically, the insulation block 2 is symmetric with respect to a first symmetry axis 23 extending in a first direction, symmetric with respect to a second symmetry axis 24 extending in a second direction, and centrosymmetric with respect to a center point O of the rounded rectangle. In this solution, impedance around a signal is symmetric, to help improve the signal transmission performance. In a specific embodiment, the first symmetry axis 23 is perpendicular to the second symmetry axis 24.

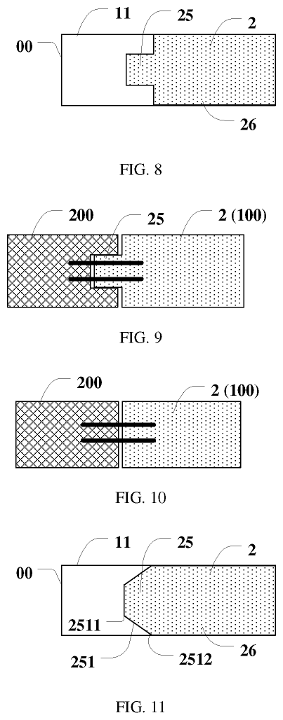

FIG. 8 is a schematic side view of a structure of the insulation block 2 and the first housing 11 according to an embodiment of this application. With reference to FIG. 6 and FIG. 8, the insulation block 2 includes a first part 25 and a second part 26 that are sequentially arranged in a direction away from the insertion/removal end 00. The first part 25 and the second part 26 are located in the inner cavity of the first housing 11. An area of a cross section of the first part 25 along the first plane is less than an area of a cross section of the second part 26 along the first plane.

FIG. 9 is a diagram of a structure in which a peer connector is inserted into a high-speed connector according to an embodiment of this application. As shown in FIG. 9, to adapt to the insulation block 2, an insulation structure of a peer connector 200 may include an accommodation groove adapted to the first part 25. When the peer connector 200 is inserted into the high-speed connector 100 in this application, the first part 25 is accommodated in the accommodation groove of the peer connector 200. When there is a gap between the high-speed connector 100 and the peer connector 200, the gap is not a continuous gap. FIG. 10 is a diagram of a structure in which a peer connector is inserted into a connector in the conventional technology. As shown in FIG. 10, in the conventional technology, when there is a gap between the high-speed connector 100 and the peer connector 200, the gap is a planar gap, and a void appears at the gap, resulting in impedance discontinuity. As shown in FIG. 9, the void can be avoided in this application. Even if there is a gap between the high-speed connector 100 and the peer connector 200, a medium exists on a plane on which the gap is located. In this way, impedance of the high-speed connector 100 is continuous, to help improve signal transmission performance. In addition, the high-speed connector 100 can have greater demating compatibility.

As shown in FIG. 8, in an embodiment, each circumferential side surface of the first part 25 of the insulation block 2 may be a plane parallel to the insertion/removal direction M. For example, a shape of the cross section of the first part 25 along the first plane may also be a rounded rectangle or a rectangle. This helps simplify a structure of the high-speed connector 100 and improve fabrication precision of the insulation block 2, to enhance an impedance control capability of the high-speed connector 100 and improve signal transmission performance.

FIG. 11 is a schematic side view of a structure of the insulation block 2 and the first housing 11 according to an embodiment of this application. As shown in FIG. 6 and FIG. 11, each circumferential side surface of the first part 25 of the insulation block 2 is a first inclined surface 251. The first inclined surface 251 includes a first end 2511 and a second end 2512 that are sequentially arranged in the direction away from the insertion/removal end 00. A distance between the first end 2511 and an adjacent surface of the metal housing 1 is greater than a distance between the second end 2512 and the adjacent surface of the metal housing 1. In other words, in cross sections of the first part 25 along the first plane, the cross section closer to the second part 26 has a larger area, or the cross section at a smaller distance from the second part 26 has a larger area. The first inclined surface 251 is inclined to be close to the surface of the metal housing 1 in the direction away from the insertion/removal end 00. In addition to implementing impedance continuity, the first inclined surface 251 in this embodiment may serve as a guiding surface to facilitate insertion of the peer connector 200 into the high-speed connector 100.

In an embodiment, the first inclined surface 251 is specifically a continuous inclined surface. In another embodiment, the first inclined surface 251 may alternatively be a stepped inclined surface. This is not specifically limited in this application. In addition, in an optional embodiment, the first inclined surface 251 may be a plane, a curved surface, an arc surface, or the like. This is not specifically limited in this application either.

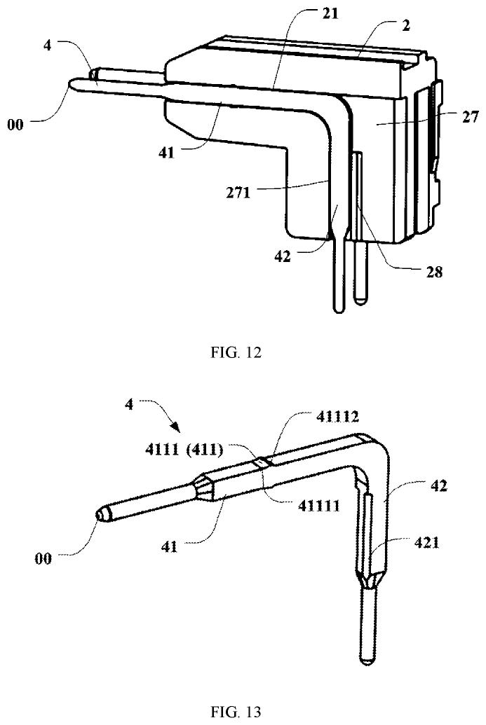

FIG. 12 is a partial sectional view of the insulation block 2 and the terminal 4 according to an embodiment of this application. As shown in FIG. 12, in an embodiment, the insulation block 2 includes a groove 27. The groove 27 is located on a side that is of the one or more accommodation holes 21 and that is away from the insertion/removal end 00. The groove 27 communicates with the one or more accommodation holes 21. Specifically, an opening of the groove 27 is located on a side away from the insertion/removal end 00. A groove bottom 271 of the groove 27 communicates with the one or more accommodation holes 21. FIG. 13 is a diagram of a structure of a terminal according to an embodiment of this application. As shown in FIG. 13, the terminal 4 includes the first terminal part 41 and a second terminal part 42. The second terminal part 42 is connected to a side that is of the first terminal part 41 and that is away from the insertion/removal end 00. An included angle is formed between the first terminal part 41 and the second terminal part 42. When the terminal 4 is assembled, the terminal 4 is inserted into the insulation block 2 from the opening of the groove 27 in a direction toward the insertion/removal end 00, with the first terminal part 41 inserted into the accommodation hole 21 in the insulation block 2. The insulation block 2 includes a limiting rod 28. The limiting rod 28 is located on a side wall of the groove 27 and spaced apart from the groove bottom 271 of the groove 27. The limiting rod 28 and the groove bottom 271 of the groove 27 are configured to limit the terminal 4, to reduce a probability of terminal withdrawal and lower a risk of pin back-out.

In a specific embodiment, the foregoing included angle may be 90°, to help improve cooperation between the terminal 4 and the groove bottom 271 of the insulation block 2. In addition, little overlap between projections of the first terminal part 41 and the second terminal part 42 helps reduce signal crosstalk and improve performance and a speed of transmitting a signal by the high-speed connector 100.

With reference to FIG. 12 and FIG. 13, there is a guiding surface 421 at an edge of a surface that is of the second terminal part 42 and that faces the insertion/removal end 00, so that the second terminal part 42 easily crosses the limiting rod 28. A surface that is of the second terminal part 42 and that is away from the insertion/removal end 00 is a plane, so that the surface that is of the second terminal part 42 and that is away from the insertion/removal end 00 is reliably clamped to the limiting rod 28. In a specific embodiment, a distance between the limiting rod 28 and the groove bottom 271 of the groove 27 may be a thickness of the second terminal part 42 in the insertion/removal direction M, to improve reliability of the terminal 4 in the insulation block 2. In a specific embodiment, the insulation block 2 has flexibility, and the limiting rod 28 may also have flexibility. In this way, when the second terminal part 42 is inserted into the groove 27, the insulation block 2 and/or the limiting rod 28 are/is deformed, so that a thickness of the groove 27 increases, and the second terminal part 42 can cross a position at which the limiting rod 28 is located. After the second terminal part 42 crosses the position at which the limiting rod 28 is located, the insulation block 2 and/or the limiting rod 28 are/is restored to their original shapes, and the second terminal part 42 can be clamped to a side that is of the limiting rod 28 and that faces the insertion/removal end 00, so that the second terminal part 42 is reliably limited in the insulation block 2.

With continued reference to FIG. 12 and FIG. 13, to improve reliability of a connection between the terminal 4 and the insulation block 2, a first surface of the first terminal part 41 may include a protrusion part 411. The protrusion part 411 includes a second inclined surface 4111. The second inclined surface 4111 includes a third end 41111 and a fourth end 41112 that are sequentially arranged in the direction away from the insertion/removal end 00. A distance between the third end 41111 and the first surface is less than a distance between the fourth end 41112 and the first surface. In a process of inserting the first terminal part 41 into the accommodation hole 21, the second inclined surface 4111 has a guiding function, and the first terminal part 41 is inserted with little obstruction. An included angle between the second inclined surface 4111 and an end face that is of the protrusion part 411 and that is away from the insertion/removal end 00 is an acute angle, so that the protrusion part 411 is of a barbed structure. In this way, when the first terminal part 41 moves relative to the insulation block 2 in the direction away from the insertion/removal end 00, large friction between the protrusion part 411 and an inner wall of the accommodation hole 21 helps increase difficulty of withdrawing the terminal 4 from the insulation block 2 and lower the risk of pin back-out.

In a specific embodiment, the end face that is of the protrusion part 411 and that is away from the insertion/removal end 00 is of a serrated structure, to help further increase the friction between the protrusion part 411 and the inner wall of the accommodation hole 21 in the insulation block 2.

In an optional embodiment, one surface of the first terminal part 41 may be provided with the protrusion part 411, or two or more surfaces of the first terminal part 41 may be provided with the protrusion part 411. For example, in the embodiments shown in FIG. 12 and FIG. 13, two opposite surfaces of the first terminal part 41 each have one protrusion part 411.

In an optional embodiment, a quantity of protrusion part 411 disposed on one surface of the first terminal part 41 is not limited either. Only one protrusion part 411 may be disposed. Alternatively, two or more protrusion part 411 may be disposed based on an actual requirement, to i ncrease friction between the first terminal part 41 and the insulation block 2 and improve reliability of fastening the first terminal part 41 in the accommodation hole 21.

With continued reference to FIG. 2 and FIG. 3, the metal housing 1 in this application further includes a second housing 12. The second housing 12 is connected to the first housing 11. The second housing 12 is located on a side that is of the first housing 11 and that is away from the insertion/removal end 00. The second terminal part 42 is located in an inner cavity of the second housing 12. Specifically, the second housing 12 and the first housing 11 may be integrally formed. Alternatively, the first housing 11 and the second housing 12 may be separately fabricated, and the first housing 11 and the second housing 12 are connected through welding or another connection process.

With continued reference to FIG. 3, the second housing 12 has an opening opposite to the insulation block 2. The insulation block 2 extends into the metal housing 1 from the opening, with a partial structure of the insulation block 2 extending into the first housing 11. A metal plate 121 is detachably assembled in the second housing 12. The metal plate 121 is located on a side that is of the second terminal part 42 and that is away from the insertion/removal end 00. The second housing 12 and the metal plate 121 may also shield interference of the terminal 4, to improve the signal transmission performance of the high-speed connector 100.

During specific implementation, there are a plurality of options for detachably assembling the metal plate 121 in the second housing 12. This is not limited in this application. For example, the metal plate 121 may be fastened to the second housing 12 through a screw, or the metal plate 121 may be clamped to the second housing 12.

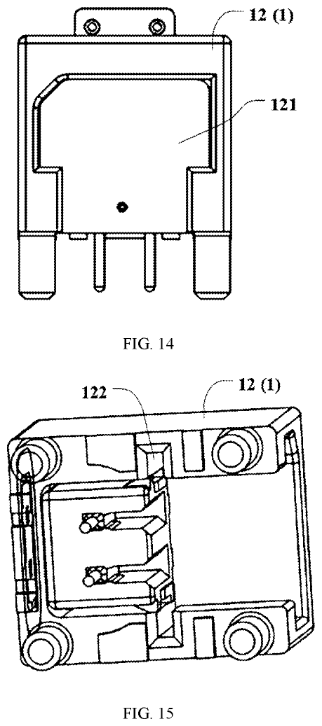

FIG. 14 is a schematic rear view of a structure of a high-speed connector according to an embodiment of this application. FIG. 15 is a diagram of a structure with the metal plate 121 removed according to an embodiment of this application. FIG. 16 is a diagram of a structure of the metal plate 121 according to an embodiment of this application. As shown in FIG. 14, FIG. 15, and FIG. 16, the second housing 12 may include a slot 122. The metal plate 121 is inserted into the slot 122. As shown in FIG. 16, a surface of the metal plate 121 further includes one or more protrusions 1211. The protrusions 1211 are located on a surface that is of the metal plate 121 and that faces the insulation block 2. The protrusions 1211 abut against the insulation block 2. In this solution, large friction between the metal plate 121 and the insulation block 2 can improve assembly reliability of the metal plate 121 and prevent it from easily falling out of the slot 122, to improve shielding reliability of the high-speed connector 100.

As shown in FIG. 16, in an optional embodiment, the protrusions 1211 are circular protrusions. When the metal plate 121 may include a plurality of protrusions 1211, the plurality of protrusions 1211 are sequentially spaced apart in a straight line.

A notch may be further provided at a corner of the metal plate 121. Correspondingly, the second housing 12 further has a protrusion part adapted to the notch. The notch and the protrusion part serve as a foolproof structure of the metal plate 121, and the protrusion part may face the insulation block 2.

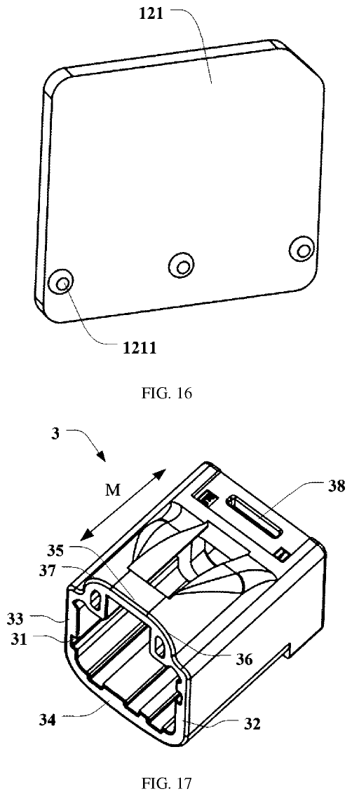

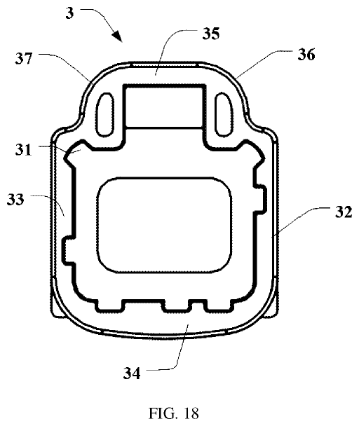

FIG. 17 is a diagram of a structure of the protective sleeve 3 according to an embodiment of this application. As shown in FIG. 2, FIG. 3, and FIG. 17, the protective sleeve 3 in embodiments of this application may be an insulation protective sleeve. The insulation protective sleeve is sleeved on an outer side of the first housing 11 and fastened to the metal housing 1. FIG. 18 is a schematic front view of a structure of the protective sleeve 3 according to an embodiment of this application. As shown in FIG. 17 and FIG. 18, an inner side that is of the protective sleeve 3 and that faces the first housing 11 includes at least one guiding groove 31. The guiding groove 31 extends in the insertion/removal direction M of the high-speed connector 100. The guiding groove 31 may serve as a guiding structure for inserting the peer connector into the connector in this embodiment, to facilitate a smooth connection between the two high-speed connectors through insertion. In this solution, quantities and positions of guiding grooves 31 of different types of high-speed connectors may be different, so that the guiding groove 31 may further serve as a foolproof structure, to prevent incorrect insertion of high-speed connectors with different functions and models.

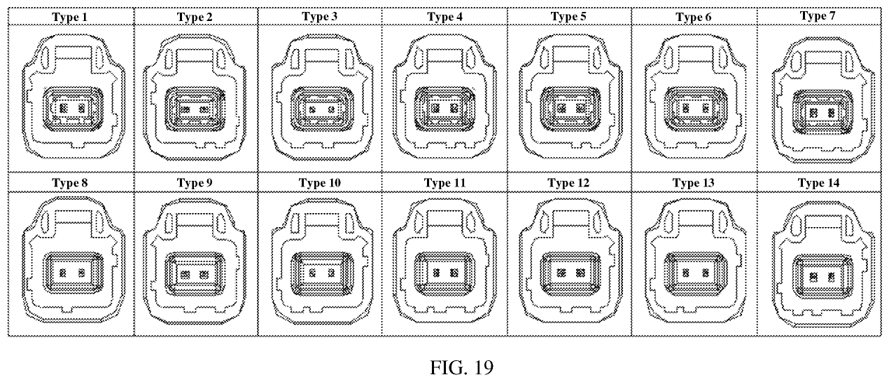

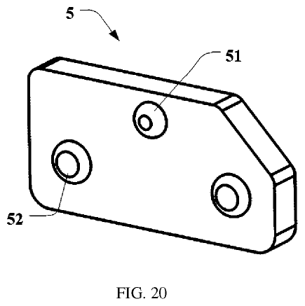

FIG. 19 is a diagram of different manners of providing a guiding groove of a protective sleeve according to an embodiment of this application. As shown in FIG. 19, the quantity and positions of guiding grooves are adjusted, so that different types of high-speed connectors can be easily distinguished and are not prone to incorrect insertion.

In addition, as shown in FIG. 17 and FIG. 18, the protective sleeve 3 includes a first side plate 32, a second side plate 33, a third side plate 34, and a clamping plate 35. The first side plate 32 is opposite to the second side plate 33. The third side plate 34 is opposite to the clamping plate 35. A distance between the clamping plate 35 and the third side plate 34 is greater than a distance between the third side plate 34 and an end that is of the first side plate 32 and that is away from the third side plate 34. The clamping plate 35 is connected to the first side plate 32 through a first arc-shaped plate 36. The distance between the clamping plate 35 and the third side plate 34 is greater than a distance between the third side plate 34 and an end that is of the second side plate 33 and that is away from the third side plate 34. The clamping plate 35 is connected to the second side plate 33 through a second arc-shaped plate 37. Four side surfaces of the protective sleeve 3 are understood as roughly planes. The clamping plate 35 may be considered as an arched clamping plate 35 that protrudes from the planes of the side surfaces of the protective sleeve 3. Specifically, the first arc-shaped plate 36, the clamping plate 35, and the second arc-shaped plate 37 enclose a clamping opening. Two ends of the clamping plate 35 are connected to the side plates at the two ends through the arc-shaped plates, to improve a force-bearing form of the clamping plate 35 and help enhance structural strength of the protective sleeve 3.

To enhance strength of the clamping opening of the protective sleeve 3, the first arc-shaped plate and the second arc-shaped plate may be further provided with a reinforcing part, for example, a reinforcing rib or a reinforcing block, so that structural strength of positions at which the first arc-shaped plate and the second arc-shaped plate are located is strong, and connections between the clamping plate 35 and both the first side plate 32 and the second side plate 33 have strong strength and are not prone to damage.

As shown in FIG. 2, FIG. 3, and FIG. 17, in an embodiment, to fasten the protective sleeve 3 to the metal housing 1, the protective sleeve 3 includes a through hole 38, and the metal housing 1 includes a clamping groove 13. The high-speed connector 100 includes a stop pin 5. The stop pin 5 passes through the through hole 38 and is clamped into the clamping groove 13. In this way, the protective sleeve 3 is fastened to the metal housing 1.

FIG. 20 is a diagram of a structure of the stop pin 5 according to an embodiment of this application. With reference to FIG. 20, a surface of the stop pin 5 further includes a bump. The bump abuts against the through hole 38 of the protective sleeve 3 or the clamping groove 13, to improve reliability of fastening the stop pin 5 in the through hole 38 and the clamping groove 13. Specifically, the bump may be a circular bump, to simplify a process of fabricating the stop pin 5.

In a specific embodiment, the bump on the surface of the stop pin 5 specifically includes a first bump 51 and a second bump 52. The first bump 51 abuts against an inner wall of the through hole 38 of the protective sleeve 3. The second bump 52 abuts against a side wall of the clamping groove 13 of the metal housing 1. An area of an orthographic projection of the second bump 52 on the surface of the stop pin 5 is greater than an area of an orthographic projection of the first bump 51 on the surface of the stop pin 5. Because a surface of the metal housing 1 and a surface of the insulation block 2 deform to different degrees, and the area of the second bump 52 is greater than the area of the first bump 51, a contact area of the stop pin 5 and the surface of the metal housing 1 is greater than a contact area of the stop pin 5 and the insulation block 2, so that the stop pin 5 is reliably fastened to the metal housing 1 and the insulation block 2, to improve reliability of fastening the protective sleeve 3 to the metal housing 1.

Based on a same inventive concept, this application further provides a signal transmission method, which is specifically a method for transmitting a signal through the high-speed connector in the foregoing embodiments. Specifically, the one or more terminals of the high-speed connector include a power terminal and a communication terminal. The signal transmission method specifically includes: transmitting a power signal through the power terminal; and transmitting a communication signal through the communication terminal. In the signal transmission method, a signal transmission speed is high, and a loss is small.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A high-speed connector, comprising a metal housing and one or more terminals, wherein an end that is of each of the one or more terminals and that faces an insertion/removal end of the high-speed connector is a first terminal part, the metal housing comprises a first housing, and the first terminal part is located in an inner cavity of the first housing; and
a shape of a cross section of the first housing along a first plane is a rounded rectangle, and the first plane is perpendicular to an insertion/removal direction of the high-speed connector.

2. The high-speed connector according to claim 1, further comprising an insulation block, wherein the insulation block is assembled in the metal housing, the insulation block comprises one or more accommodation holes, and the plurality of terminals pass through the one or more accommodation holes.

3. The high-speed connector according to claim 2, wherein an outer circumferential surface that is of the insulation block and that faces the metal housing comprises a plurality of protrusion structures, and surfaces that are of the plurality of protrusion structures and that face the metal housing are attached to the metal housing.

4. The high-speed connector according to claim 2, wherein the insulation block comprises a first part and a second part that are sequentially arranged in a direction away from the insertion/removal end, the first part and the second part are located in the inner cavity of the first housing, and an area of a cross section of the first part along the first plane is less than an area of a cross section of the second part along the first plane.

5. The high-speed connector according to claim 4, wherein each circumferential side surface of the first part is a first inclined surface, the first inclined surface comprises a first end and a second end that are sequentially arranged in the direction away from the insertion/removal end, and a distance between the first end and an adjacent surface of the metal housing is greater than a distance between the second end and the adjacent surface of the metal housing.

6. The high-speed connector according to claim 2, wherein the insulation block comprises a groove, the groove is located on a side that is of the one or more accommodation holes and that is away from the insertion/removal end, and the groove communicates with the one or more accommodation holes; and the insulation block comprises a limiting rod, and the limiting rod is located on a side wall of the groove and spaced apart from a bottom of the groove.

7. The high-speed connector according to claim 1, wherein the terminal further comprises a second terminal part connected to the first terminal part, and an included angle is formed between the first terminal part and the second terminal part; and
a first surface of the first terminal part comprises a protrusion part, the protrusion part comprises a second inclined surface, the second inclined surface comprises a third end and a fourth end that are sequentially arranged in the direction away from the insertion/removal end, a distance between the third end and the first surface is less than a distance between the fourth end and the first surface, and an included angle between the second inclined surface and an end face that is of the protrusion part and that is away from the insertion/removal end is an acute angle.

8. The high-speed connector according to claim 7, wherein there is a guiding surface at an edge of a surface that is of the second terminal part and that faces the insertion/removal end, and a surface that is of the second terminal part and that is away from the insertion/removal end is a plane.

9. The high-speed connector according to claim 1, wherein the terminal further comprises the second terminal part connected to the first terminal part, and an included angle is formed between the first terminal part and the second terminal part; the metal housing further comprises a second housing, the second housing is connected to the first housing, and the second housing is located on a side that is of the first housing and that is away from the insertion/removal end; and the second terminal part is located in an inner cavity of the second housing; and
a metal plate is detachably assembled in the second housing, and the metal plate is located on a side that is of the second terminal part and that is away from the insertion/removal end.

10. The high-speed connector according to claim 1, further comprising a protective sleeve, wherein the protective sleeve is sleeved on an outer side of the first housing and fastened to the metal housing; and
an inner side that is of the protective sleeve and that faces the first housing comprises at least one guiding groove, and the guiding groove extends in the insertion/removal direction of the high-speed connector.

11. The high-speed connector according to claim 10, wherein the protective sleeve comprises a first side plate, a second side plate, a third side plate, and a clamping plate, the first side plate is opposite to the second side plate, and the third side plate is opposite to the clamping plate;
a distance between the clamping plate and the third side plate is greater than a distance between the third side plate and an end that is of the first side plate and that is away from the third side plate, the clamping plate is connected to the first side plate through a first arc-shaped plate, the distance between the clamping plate and the third side plate is greater than a distance between the third side plate and an end that is of the second side plate and that is away from the third side plate, and the clamping plate is connected to the second side plate through a second arc-shaped plate; and
the first arc-shaped plate, the clamping plate, and the second arc-shaped plate enclose a clamping opening.

12. The high-speed connector according to claim 10, further comprising a stop pin, wherein the protective sleeve comprises a through hole, the metal housing comprises a clamping groove, and the stop pin passes through the through hole and is clamped into the clamping groove.

13. The high-speed connector according to claim 12, wherein a surface of the stop pin comprises a first bump and a second bump, the first bump abuts against an inner wall of the through hole of the protective sleeve, the second bump abuts against a side wall of the clamping groove of the metal housing, and an area of an orthographic projection of the second bump on the surface of the stop pin is greater than an area of an orthographic projection of the first bump on the surface of the stop pin.

14. An electronic assembly, comprising an electronic component and a high-speed connector;
wherein the high-speed connector comprises a metal housing and one or more terminals, wherein an end that is of each of the one or more terminals and that faces an insertion/removal end of the high-speed connector is a first terminal part, the metal housing comprises a first housing, and the first terminal part is located in an inner cavity of the first housing; and
a shape of a cross section of the first housing along a first plane is a rounded rectangle, and the first plane is perpendicular to an insertion/removal direction of the high-speed connector;
wherein the electronic component is electrically connected to the one or more terminals of the high-speed connector.

15. The electronic assembly according to claim 14, further comprising an insulation block, wherein the insulation block is assembled in the metal housing, the insulation block comprises one or more accommodation holes, and the plurality of terminals pass through the one or more accommodation holes.

16. The electronic assembly according to claim 15, wherein an outer circumferential surface that is of the insulation block and that faces the metal housing comprises a plurality of protrusion structures, and surfaces that are of the plurality of protrusion structures and that face the metal housing are attached to the metal housing.

17. The electronic assembly according to claim 15, wherein the insulation block comprises a first part and a second part that are sequentially arranged in a direction away from the insertion/removal end, the first part and the second part are located in the inner cavity of the first housing, and an area of a cross section of the first part along the first plane is less than an area of a cross section of the second part along the first plane.

18. An electronic device, comprising a peer connector and an electronic assembly;
wherein the electronic assembly comprises an electronic component and a high-speed connector;
wherein the high-speed connector comprises a metal housing and one or more terminals, wherein an end that is of each of the one or more terminals and that faces an insertion/removal end of the high-speed connector is a first terminal part, the metal housing comprises a first housing, and the first terminal part is located in an inner cavity of the first housing; and
a shape of a cross section of the first housing along a first plane is a rounded rectangle, and the first plane is perpendicular to an insertion/removal direction of the high-speed connector;
wherein the electronic component is electrically connected to the one or more terminals of the high-speed connector. wherein the peer connector is inserted into the high-speed connector.

19. The electronic device according to claim 18, further comprising an insulation block, wherein the insulation block is assembled in the metal housing, the insulation block comprises one or more accommodation holes, and the plurality of terminals pass through the one or more accommodation holes.

20. The electronic device according to claim 19, wherein an outer circumferential surface that is of the insulation block and that faces the metal housing comprises a plurality of protrusion structures, and surfaces that are of the plurality of protrusion structures and that face the metal housing are attached to the metal housing.
